(19) United States
(12) Patent Application Publication
(10) Pub. No.: US 2014/0026058 A1
(43) Pub. Date: Jan. 23, 2014

(54) Establishing System and Method for Establishing Application Program Having Capability Controlling Input and Output Interface for Mobile Computing Device

(71) Applicant: EverMore Technology Inc., Hsinchu City (TW)

(72) Inventors: JUI-CHI JAO, New Taipei City (TW); YUAN-SHENG CHEN, Hsinchu City (TW); WU-HSIUNG HUANG, Hsinchu City (TW); TSU-PIN WENG, Hsinchu City (TW)

(73) Assignee: EverMore Technology Inc., Hsinchu City (TW)

(21) Appl. No.: 13/934,836

(22) Filed: Jul. 3, 2013

(30) Foreign Application Priority Data
Jul. 3, 2012 (TW) 101123945

(51) Int. Cl. H04L 12/24

(52) U.S. Cl. CPC H04L 41/22
USPC 715/736

(57) ABSTRACT

The present invention relates to an establishing system and a method for providing a user accessing an establishing platform having a user interface through a browser for establishing application program for mobile computing device and having capability controlling input and output interface for a mobile computing device, wherein the input and output interface adopts a wireless communication protocol for bi-directionally communicating with an external device, the user interface comprises a input and output interface management module configured to provide the user to define the contents for the wireless communication protocol.

### FIELD

The present invention relates to a system for establishing an application program for a mobile computing device and a method thereof. In particular, it relates to a system rendering a user being capable of independently establishing an application program for a mobile computing device having a capability controlling an input and output interface for a mobile computing device.

### BACKGROUND

In recent years, the improvement of technology drove the improvement and popularization of smaller and better mobile computing device such as a smart phone and a tablet. The operation systems of these mobile computing devices render encoders and users to use the particular code of these operating systems to compile various applications (so-called App) and execute such applications on the mobile computing devices on their own. The types of these Apps comprise the aspects of game, finance, GPS, call management, system monitor, online messaging, location based service (LBS) and the like.

However, it is required to learn an Android SDK developing platform, an Eclipse developing environment, related techniques of WEB, and Java codes in sequence for designing and developing the most popular App application of the Android phone. It wastes a lot of time. The completed application is not run on a real mobile phone but on the computer with a simulation. The long-winded and inefficient learning makes the learner depressed, even giving up learning.

The user is required to have complicated coding abilities with Html, Android, and iOS to compile an App. In addition to good coding abilities, an App needs bountiful and eye-catching digital contents. Therefore an App takes enormous design and planning from an idea to the completion. So that the App establishing platform starts to develop, particularly a simple, idiot-proof App establishing platform. The user can easily make a customized App by the guide of the App establishing platform without knowing related WEB techniques, HTML5, and App developing techniques. But the App not only simply executes particular functions on the mobile computing device but cooperates with the communicating interface of the I/O interface on the mobile computing device to control external devices. For example, the App controls hardware of a printer connected to the mobile computing device via Bluetooth wireless connection through the Bluetooth wireless communication on the mobile computing device.

But the current App establishing platform only allows the user to build an App which simply executes particular functions on the mobile computing device and it cannot allow the user to build an App which further comprises capacity controlling external hardware device or build an App which executes particular functions on the mobile computing device and has capacity controlling external hardware device. Such App is needed indeed.

There is a need to solve the above deficiencies/issues.

### SUMMARY

The present invention proposes a platform for establish I/O interface App by the cloud computing. There is no need to memorize the commands and codes. The user can log in the platform, explicitly define the communication protocol of the device which is going to be controlled, and complete the data field to easily accomplish the I/O interface controlling APP without the need to know Java codes. And then the user can easily control the sounding device such as remote car, intelligence home, GPS, scale meter, heartbeat and blood pleasure meter in life by a smart phone through wireless communicating interface like Bluetooth and Wi-Fi.

According to the first aspect of the present invention, a user interface, which is implemented on a computer-readable medium and executable on a computer, for rendering a user being capable of independently establishing an application program for a mobile computing device having a capability controlling an input and output interface for a mobile computing device, wherein the input and output interface adopts a wireless communication protocol for bi-directionally communicating with an external device and the user interface comprises an input and output interface management module configured to render the user to define contents for the wireless communication protocol.

According to the second aspect of the present invention, an application program establishing method for a mobile computing device which renders a user to access an establishing platform having a user interface through a browser for establishing an application program for a mobile computing device, wherein the application program has capability controlling an input and output interface for a mobile computing device, and the input and output interface adopts a wireless communication protocol for bi-directionally communicating with an external device, and the method comprises providing the user interface which comprises an input/output interface management module configured to render the user to define contents for the wireless communication protocol.

According to the third aspect of the present invention, an application program establishing system for a mobile computing device which renders a user to access an establishing platform having a user interface through a browser for establishing an application program for a mobile computing device, wherein the application program has capability controlling an input and output interface for a mobile computing device, and the input and output interface adopts a wireless communication protocol for bi-directionally communicating with an external device, and the system comprises a cloud computing server with the establishing platform installed thereon; and a user end which connects to the establishing platform through an Internet and can execute the browser, wherein the user accesses the establishing platform through the browser and the establishing platform further comprises an input/output interface management module configured to render the user to define contents for the wireless communication protocol.

### DESCRIPTION OF THE DRAWINGS

A more complete appreciation of the invention and many of the attendant advantages thereof are readily obtained as the same become better understood by reference to the following detailed description when considered in connection with the accompanying drawing, wherein:

FIG. 1 is a schematic diagram of the present invention;

FIG. 2 is a schematic diagram illustrating a user interface (UI) of the establishing platform in accordance with the present disclosure;

FIG. 3 is a schematic diagram illustrating an I/O interface management page in accordance with the present disclosure;

FIGS. 4(a) and 4(b) are schematic diagrams illustrating a parameters-defining page for the I/O interface communication protocol in accordance with the present disclosure;

FIG. 5 is a schematic diagram illustrating a shortcut icon of an App, having a capability of controlling external devices, on the desktop of the smart phone in accordance with the present disclosure;

FIGS. 6(a) and 6(b) are schematic diagrams illustrating an launched App having a capability of controlling external devices in accordance with the present disclosure;

FIG. 7 is a schematic diagram illustrating a screen of the smart phone about requesting permission for a user to enable the Bluetooth communication protocol on an end of the App in accordance with the present disclosure;

FIG. 8 is a schematic diagram illustrating a screen of a smart phone when the function of enabling the body scale is enabled on the end of the App in accordance with the present disclosure;

FIG. 9 is a schematic diagram illustrating an uploading screen of the mobile phone for uploading the weight data to the cloud computing database on the end of the App in accordance with the present disclosure;

FIG. 10 is a schematic diagram illustrating management page of data detail of I/O interface of the external device on the end of establishing platform in accordance with the present disclosure; and

FIG. 11 is a schematic diagram illustrating the management page about data detail of I/O interface for the external device on a screen of a smart phone.

### DETAILED DESCRIPTION

The present disclosure will be described with respect to particular embodiments and with reference to certain drawings, but the disclosure is not limited thereto but is only limited by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice.

It is to be noticed that the term “including”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device including means A and B” should not be limited to devices consisting only of components A and B.

The disclosure will now be described by a detailed description of several embodiments. It is clear that other embodiments can be configured according to the knowledge of persons skilled in the art without departing from the true technical teaching of the present disclosure, the claimed disclosure being limited only by the terms of the appended claims.

The present invention adopts cloud computing technology including Software as a Service (SaaS), Platform as a Service (PaaS) and Infrastructure as a Service, IaaS and the like. The service provider is the could computing service supplier providing cloud computing technologies (SaaS, PaaS, IaaS), cloud computing server and cloud platform for establishment.

It is worth to note that the App of the present invention is an App based on the geographic information system (GIS), the global positioning system (GPS) or the location based service (LBS). The content displayed therein comprises localized geographic information and the user can realize and possess the local information more quickly and conveniently with the localized display mode.

The present invention can optionally adopt the Taiwan invention patent No, 100038225, filed on Jul. 28, 2011 by the applicant and entitled as “Method of Providing Contents for Mobile Computing Device” and disclosed that only if the App of user's mobile phone is in a status of being logged in the establishing platform, every change on the App made by the user through the establishing platform can be displayed on the App of the smart phone instantly and synchronously, wherein all contents thereof are incorporated by reference as if fully set forth herein.

The present invention can optionally adopt a technique of a community App which is particularly for specific community and an establishing method thereof (also called as technology of mother-child App) in the Taiwan invention patent No. 101102719, filed on Jan. 20, 2012 by the applicant and entitled as “Method of Establishing Community Application Program for Mobile Computing Device”, wherein all contents thereof are incorporated by reference as if fully set forth herein.

The present invention can optionally adopt a technique of an application establishing system for rendering users being capable of easily configuring the data structure of applications by a form and a selecting method, and the method thereof in the Taiwan invention patent No. 101115678, filed on May 2, 2012 by the applicant and entitled as “System and Method of Establishing Application Program for Mobile Computing Device”, wherein all contents thereof are incorporated by reference as if fully set forth herein.

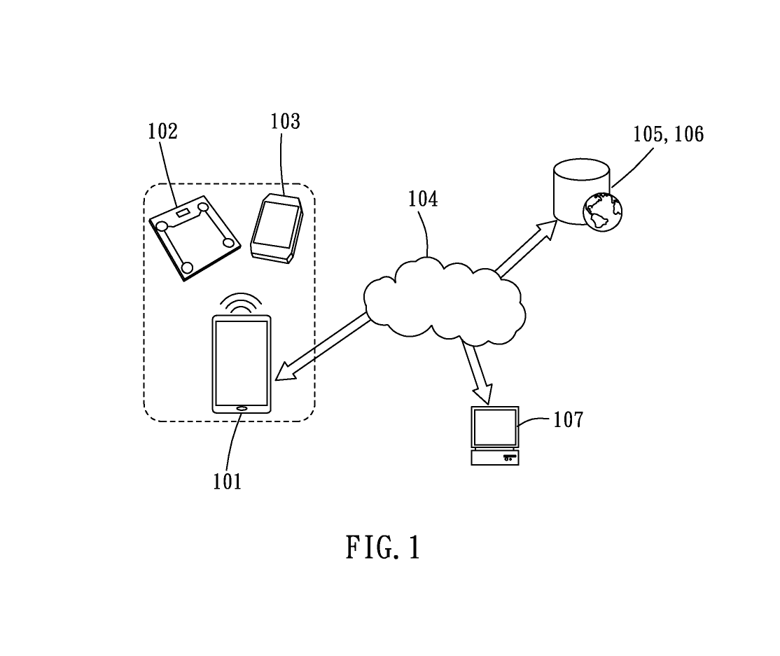

FIG. 1 is a schematic diagram of the present invention. In FIG. 1, the installed App in a smart phone 101 and such mobile computing device at the local end can process the bi-directional wireless communication of transmit/receive with a body scale 102 or a GPS 103 and such external device at the remote end via the wireless communication technology such as Wi-Fi, Bluetooth and the like, wherein the smart phone 101 connects to a cloud computing server 105 via cloud computing network 104.

An establishing platform 106 is installed on the cloud computing server 105. The establishing platform 106 is an App generator implementing the PaaS technology, wherein the App generator is made and provided by the service provider. Usually, the establishing platform 106 can provide many templates of App and release a part of content of the App to the App customizer for self-establishment so that the App customizer can make an App which meets personal requirement easily and quickly.

In some embodiments, an App customizer provides the service provider with the need and planning of the App. The service provider adjusts the App template of the establishing platform 106, adding the need into the establishing platform 106 and authorizes the App customizer to manage the functional module relating the establishment of the content of the App on the establishing platform 106 according to the need and planning of the App of the App customizer. The App customizer can use the terminal devices like a personal computer 107, a tablet or a laptop, to connect to the a cloud computing network 104 through a browser of personal computer 107 and access the functional modules, on the establishing platform 106, which is opened for App customizer to manage on the establishing platform 106. The App customizer establishes the App content which meets personal requirement independently. When the App customizer finalizes the establishment of the App content, service provider compiles the App into an installation file through establishing platform 106. For example, it is compiled into an App program with a filename extension “.apk” in the Android OS and the service provider assists the submission to Google Play. Any user can download the App program through Google Play subsequently and install on the smart phone 101 to use.

Establishing platform 106 can also be a community App which is particularly for specific community and an establishing method thereof (also called as technology of mother-child App) according to Taiwan invention patent No. 101102719. The members in the community can establish an App particularly for specific community through the technology of mother-child App on the establishing platform 106 and permit the members in the community to edit parts of the App content voluntarily.

Establishing platform 106 can also comprise an establishing system and method for providing a customizer with a form and a selecting method to easily setup the data structure of the application. The customizer can easily setup the data structure of the application by selecting customizing function for customizer and modularized function on establishing platform 106.

In the certain embodiment, establishing platform 106 comprises a series of functional modules for establishing content which enable the customizer to establish the App content voluntarily or for customizing the format of App or number of layers by a modularized method. Establishing platform 106 further comprises a functional module of an I/O interface management enabling the customizer to enable the wireless communication protocol on the I/O interface of smart phone 101.

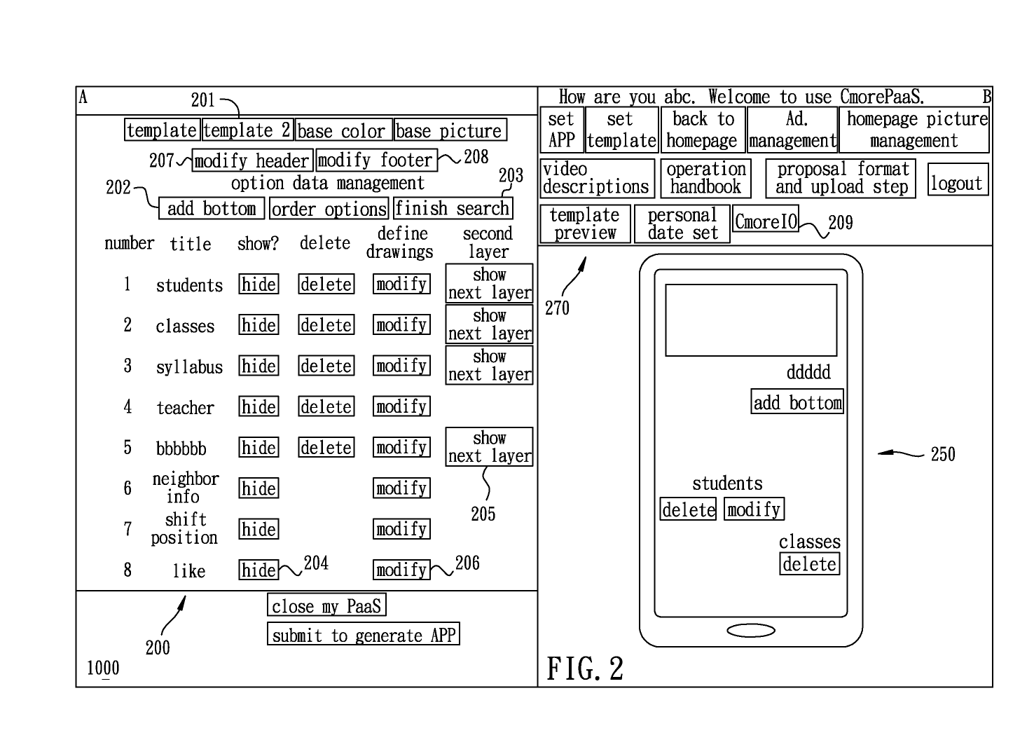

FIG. 2 is a schematic diagram illustrating a user interface (UI) of the establishing platform in accordance with the present disclosure. The user interface (UI) of the establishing platform of the present invention incorporates the technology of Taiwan invention patent No. 101115678 but excludes the technology of mother-child App therein. The user interface (UI) 1000 comprises two parts which are a configuration area of data structure A and a simulation area of mobile phone screen B. The configuration area of data structure A displays the page of selection of data management 200 and simulation area of mobile phone screen B directly displays the items and the layouts of App configured by managing the page of selection of data management 200 of configuration area of data structure A. The final outcome displayed on the screen of the mobile computing device is simulation screen of mobile phone 250. There are corresponding defining items for customizers to define by themselves in the page of selection of data management 200 of configuration area of data structure A of items and layouts of every App. Customizers can choose and configure the items and layouts of App by simply selecting each function button on the page of selection of data management 200, and see the corresponding simulation screen of mobile phone 250 instantly in the simulation area of mobile phone screen B.

There are many functional modules in the page of selection of data management 200 of configuration area of data structure A, wherein the customizers can establish the App by a simple method of selections. There functional modules are provided in a format of function buttons for customizers' operations. These function buttons comprise a template function button 201 which offers customizers 5 default layouts to pick, a adding function button 202 which configures or adds required App items, an order option function button 203 which configures the order of items, a hiding function button 204 which defines whether it shows or not, a show-next-layer function button 205 which defines the data connected further deeply, and a modification function button 206 which defines icons and the like. There are two more function buttons for managing such as an editing-header function button 207 and an editing-footer function button 208, if the page which the customer wants to configure is the home page. The purpose of the aforementioned series of modules and functions is to make customizers easily use the method of modularized functions to add to remove the content conditions such as the content of the App independently, and self-define the style conditions such as the framework, format or number of layers of the App.

In addition to the functional modules provided in the configuration area of data structure A, there is a configuration area of data management 270 in simulation area of mobile phone screen B, wherein it comprises an I/O interface management function button 209 of the I/O interface management module which the customizer can manage the operation of I/O interface. In certain embodiments, the customizer selects the I/O interface management function button 209 and enters the I/O interface management page of next layer.

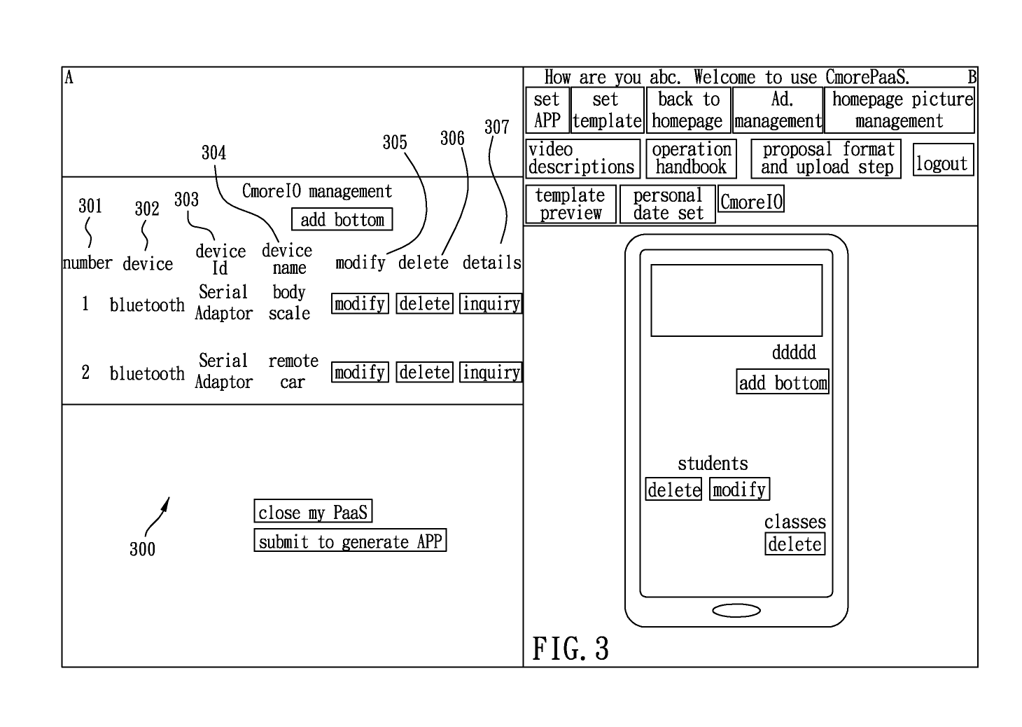

FIG. 3 is a schematic diagram illustrating an I/O interface management page in accordance with the present disclosure. After the customizer selected the I/O interface management function button 209, an I/O interface management page 300 will display in the configuration area of data structure A and the customizer can do an integrated configuration and manage a plurality of wireless communication devices with identical or different communication protocol(s) on the I/O interface of the smart phone 101. The I/O interface management page 300 lists the plurality of wireless communication devices which were already added to the I/O interface by the customizer. In the FIG. 3 of the embodiments, the customizer had added 2 external devices with Bluetooth I/O interface to the smart phone 101 such as a Serial Adaptor Bluetooth body scale on No. 1 and a Serial Adaptor Bluetooth remote-controlled car on No. 2.

The I/O interface management page 300 further offers the customizer a number field 301, a device field 302, an device ID field 303, an device name field 304, an modification function button 305, a deleting function button 306, a detail search button 307 and the like to browse and manage. In some embodiments, the customizer presses the modification function button 305 and enters the parameters-defining page for the I/O interface communication protocol of next layer, and then the customizer can further edit/self-define the parameters or the codes of the profile used in Bluetooth communication protocol of the Serial Adaptor Bluetooth body scale on No. 1.

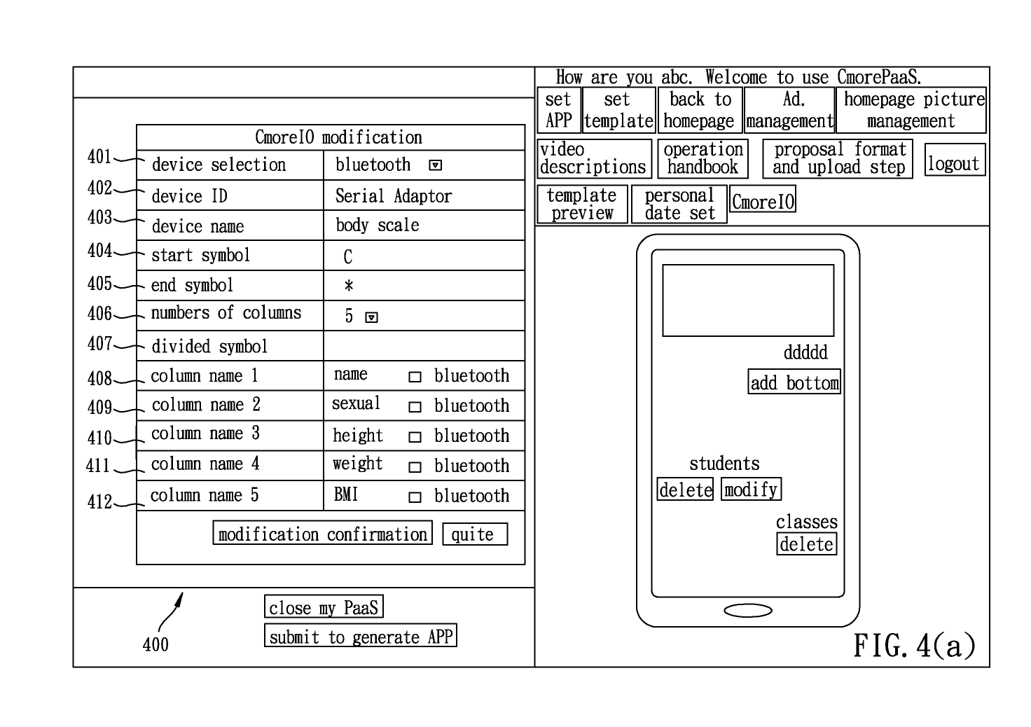

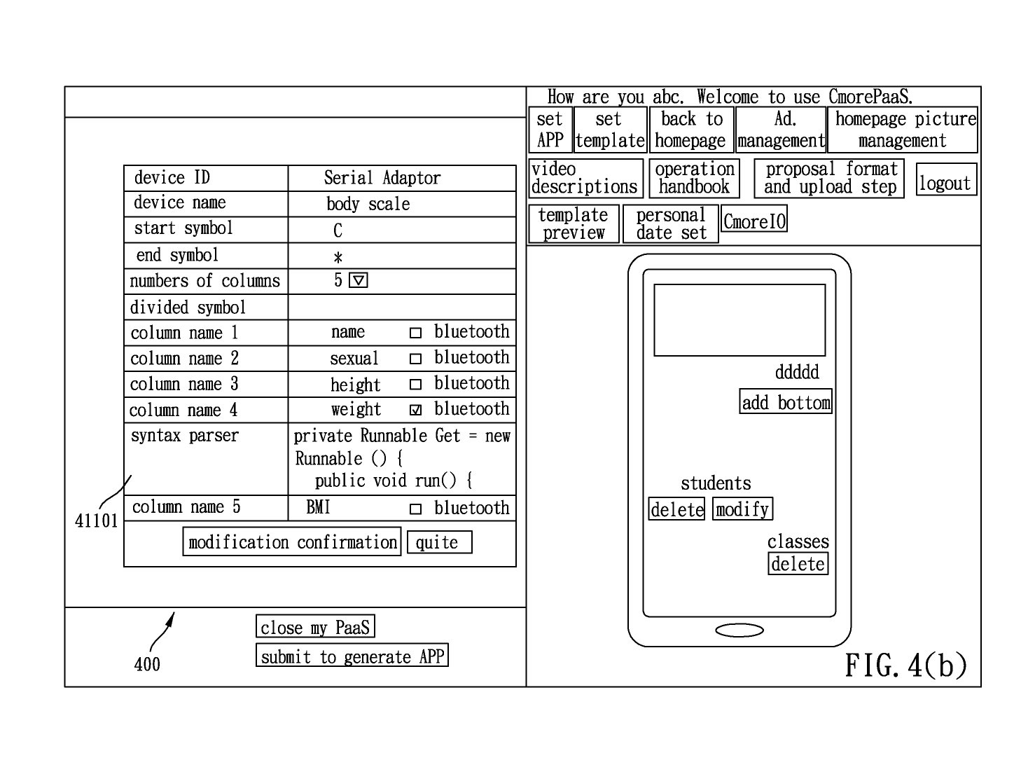

FIGS. 4(a) and 4(b) are schematic diagrams illustrating a parameters-defining page for the I/O interface communication protocol in accordance with the present disclosure. After the customizer selected the modification function button 305, a parameters-defining page for the I/O interface communication protocol 400 displays in the configuration area of data structure A, wherein the customizer can further configures the parameters of the Bluetooth profile used in the Serial Adaptor Bluetooth body scale.

The Bluetooth standard of Bluetooth Special Interest Group (SIG) comprises many communication profiles. For example, Bluetooth standard version 1.1 comprises 13 communication profiles such as, commonly used, Advance Audio Distribution Profile (A2DP), Headset Profile (HP), and Serial Port Profile (SPP) and its purpose is to ensure the interoperability among Bluetooth equipment. In some embodiments, the Bluetooth body scales on No. 1 and No. 2 use, not being restricted to, SPP profile as the communication protocol.

The rules of parameters of the Bluetooth SPP profile, authorized to the customizer for independently configuration on the parameters-defining page for the I/O interface communication protocol 400, comprise a device selection 401, an device ID 402, an device name 403, an start symbol 404, an end symbol 405, a number of columns 406, a divisional symbol 407, and a plurality of filed name for configuring parameters and codes. For example, the customizer can check the field name of profile 411 named as weight and then expand the syntax parser 41101 as shown in FIG. 4(b). The customizer can independently follow the rules of Bluetooth SPP profile and independently configure the related parameters and codes in the syntax parser 41101 in detail. The App will analyze the data retrieved from the Bluetooth end of the I/O interface according to the set rules when all the parameters and codes of Bluetooth profiles are configured.

When the customizer completes the configuration of the I/O interface through the I/O interface management module of the establishing platform 106 and also completes configuration(s) of the other functional modules, the service provider can proceed to pack the App and submit it, i.e. packing the App into a program with a filename extension “.apk” in the Android OS and submit it to Google Play. Any user can download the file with a filename extension “.apk” through Google Play subsequently and install on the smart phone 101 to use.

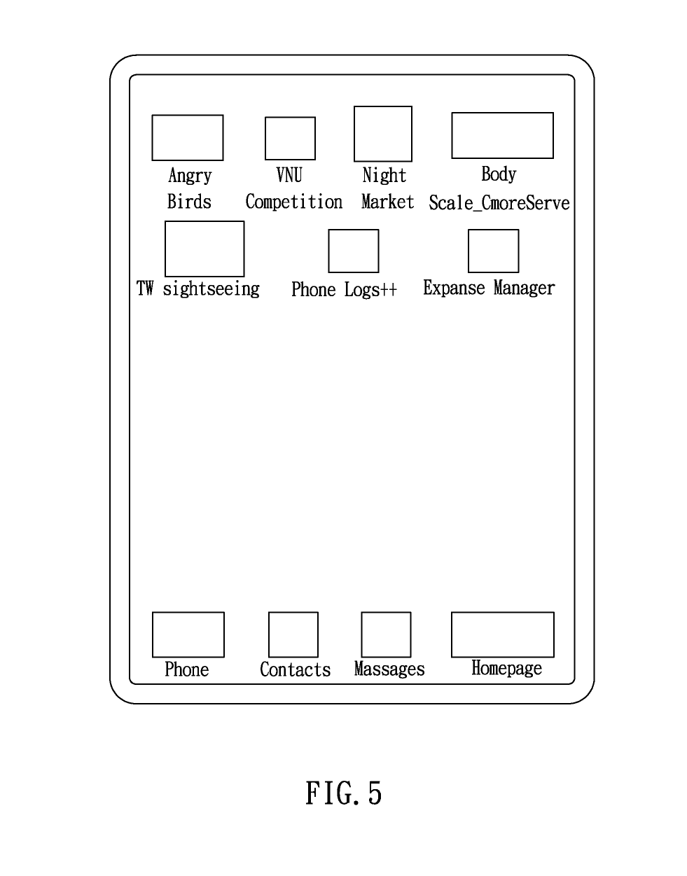

FIG. 5 is a schematic diagram illustrating a shortcut icon of an App, having a capability of controlling external devices, on the desktop of the smart phone in accordance with the present disclosure. After the user connected to Google play from the end of the smart phone 101 to download the file with a filename extension “.apk” and completed the installation, a shortcut icon of the sample App 502 is generated on the desktop 501 of the smart phone 101 and the user selects the shortcut icon of the sample App 502 to launch the sample App.

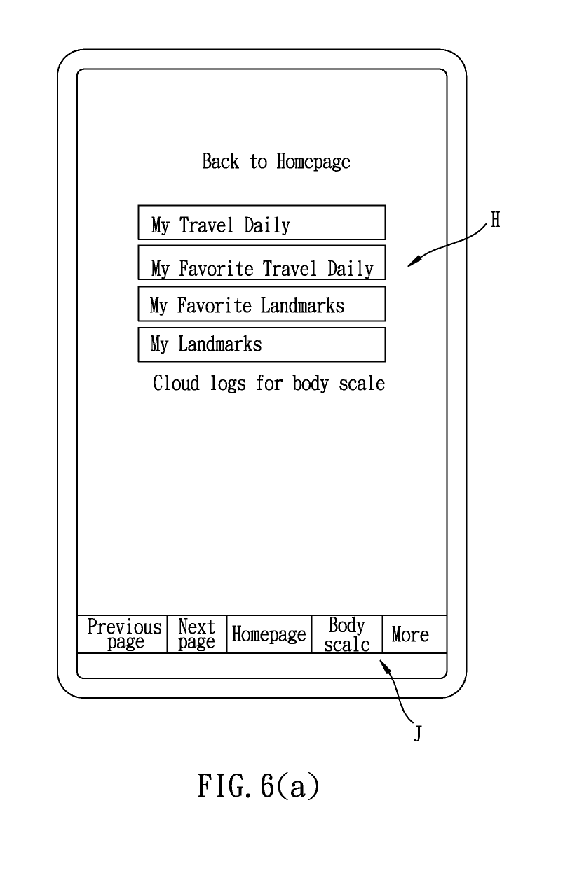

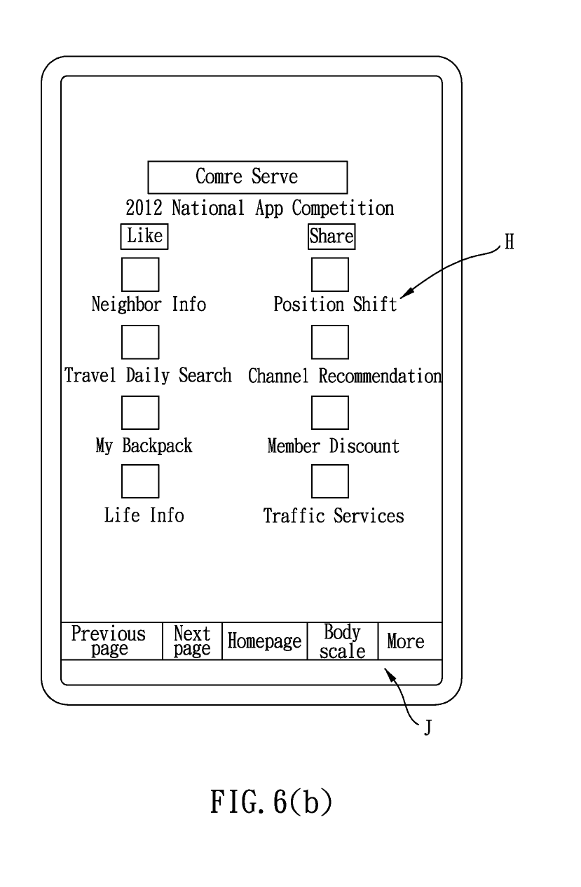

FIGS. 6(a) and 6(b) are schematic diagrams illustrating a launched App having a capability of controlling external devices in accordance with the present disclosure. After the sample App is launched, the display of the screen of the smart phone 101 will be divided into two regions comprising an information area of HTML programming H and a control area of Java programming J. The sample App showed in the information area of HTML programming H can provide information and function when the capability of controlling external devices is excluded, i.e. it simply execute the display of information and featured function on a smart phone. Two embodiments about the information area of HTML programming H shown are shown in FIGS. 6(a) and 6(b) respectively. In FIG. 6(a), a standard CmoreServe App shown in the information area of HTML programming H comprises life entertainment information in many aspects such as neighboring information, search of trip report, my backpacker, life information, switching location, recommended channel, promotion for cardholder, and traffic service and the like. In FIG. 6(b), the information area of HTML programming H comprises information such as establishing my trip report, my favorite trip report, my favorite landmark, and landmark created by myself and the like.

After the I/O interface management functional module is added into the establishing platform 106 and the customizer can enable the I/O interface thereby, the function of enabling external device will be added into the controlling stick of control area of Java programming J in the completed sample App, and become one of the controlling options. The control area of Java programming J is shown as a controlling stick at the bottom of the screen of the smart phone and keeps on the top of the screen. The control area of Java programming J comprises a plurality of control buttons controlling HTML pages and the controlling button for launching the Bluetooth body scale such as “previous page”, “next page”, “home page”, “body scale”, and “more” and the like.

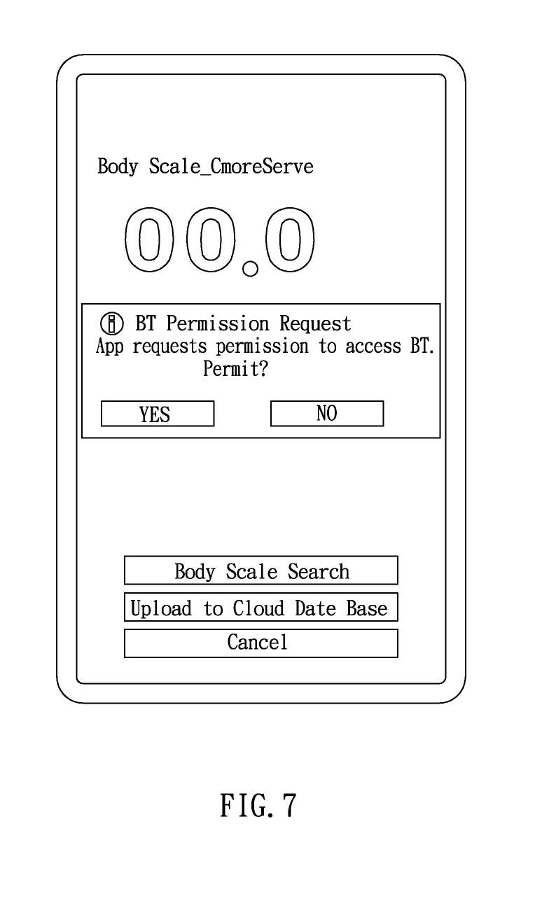

FIG. 7 is a schematic diagram illustrating a screen of the smart phone about requesting permission for a user to enable the Bluetooth communication protocol on an end of the App in accordance with the present disclosure. When the user selects the body scale button in the controlling sticks, the App will ask the user for permission to enable the Bluetooth communication protocol. The user can enable the Bluetooth interface to search the sounding external devices as pressing the enabling button.

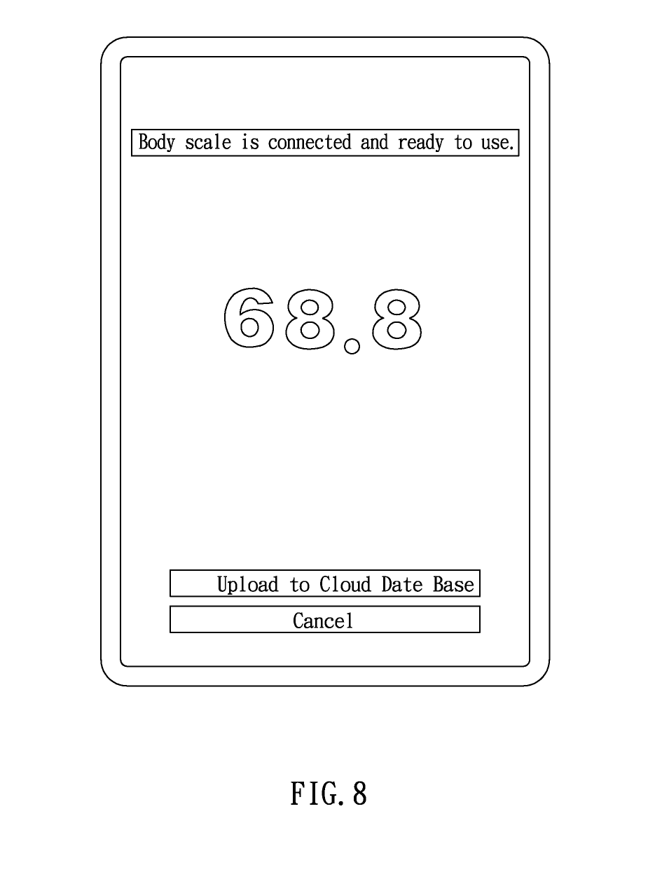

FIG. 8 is a schematic diagram illustrating a screen of a smart phone when the function of enabling the body scale is enabled on the end of the App in accordance with the present disclosure. The App starts to search the surrounding external devices for body scale which can be matched, and then the sample App analyzes the data retrieved from the Bluetooth end of the I/O interface according to the rules which was independently-configured previously and shows on the corresponding position when the smart phone is completely connected to the body scale.

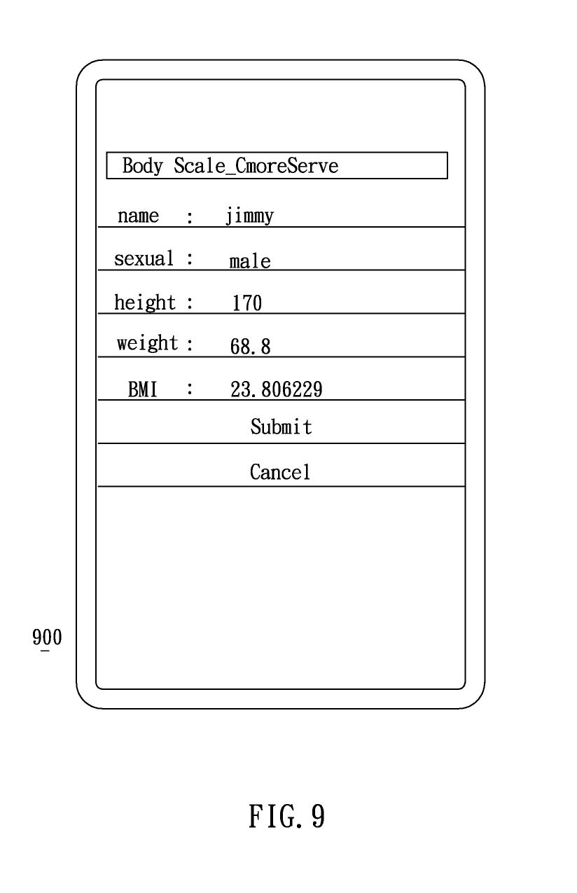

FIG. 9 is a schematic diagram illustrating an uploading screen of the mobile phone for uploading the weight data to the cloud computing database on the end of the App in accordance with the present disclosure. When the user presses the button for uploading to the cloud computing server 105, it will shows an uploading screen 900 of data on the screen of the mobile phone for uploading to the cloud computing database for storing. The customizer can defines the format and content of the uploading screen 900 independently through establishing platform 106. In some embodiments, the customizer defines the information field such as name, gender, height, weight, BMI in the uploading screen 900 and uploads to the cloud. Subsequently, the user presses the sending button 901 in the uploading screen 900 to upload data measured by the external body scale device to the cloud computing server 105 for storing.

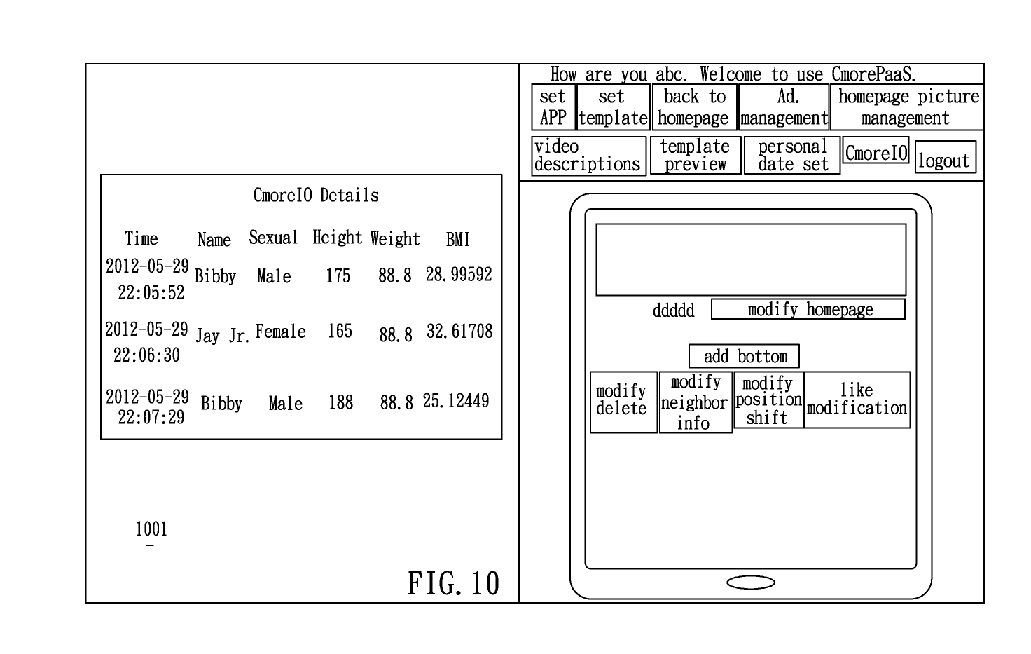

FIG. 10 is a schematic diagram illustrating management page of data detail of I/O interface of the external device on the end of establishing platform in accordance with the present disclosure. The weight data uploaded to the cloud computing server 105 for storing are classified into two categories. One is weight data of all users, and another one is a personal weight record sequence of a specific user. The weight data of all users comprises a plurality of personal weight record sequences of each user. The customizer can browse the weight data of all users (subscribers) including a plurality of personal weight record sequences of each user through the management page of data detail of I/O interface of the external device 1001 of the I/O interface management module (enabled by I/O interface management function button 209) on the establishing platform 106.

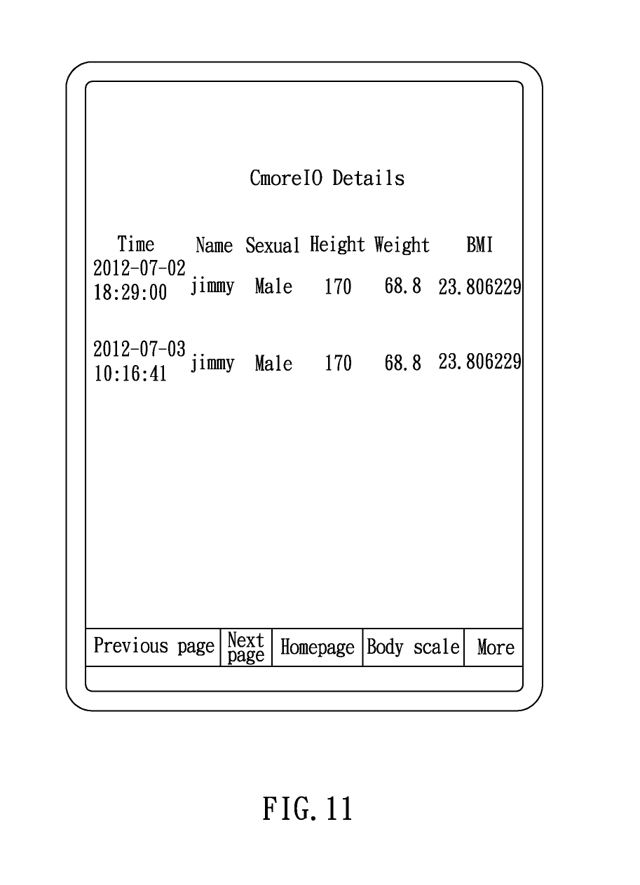

The management page of data detail of I/O interface of the external device 1001 of the establishing platform 106 also allows the users to log in and browse. The users only have to acquire the exclusive ID and password by an appropriate registration process and then the users can log in the management page of data detail of I/O interface of the external device 1001 of the establishing platform 106 to browse personal weight record sequences. The user can also log in the management page of data detail of I/O interface of the external device 1001 of the establishing platform 106 or log in “my backpacker” through a smart phone to browse personal weight record sequences as shown in FIG. 11.

The customizer can further analyze these weight data interactively and use it. For example, the customizer can broadcast the losing weight information to the overweight user according to registered personal data.

Any App customizer can easily build an App which can control the body scale 102 on the remote end or GPS 103 or other external device and process a transmit/receive bi-directional communication with these external devices through the I/O interface management function module of the establishing platform 106 proposed by the present invention. In another embodiment, the App in the smart phone 101 can be integrated with external devices such as surveillance system like IP camera, heartbeat and blood pressure meter, health and medical treatment system like ear thermal meter, home care system, remote car, remote plane, intelligent home integration, or QR code scanner through the establishing platform 106 of the present invention. The application is extensive. The external devices implemented in the present invention are not restricted to the aforementioned devices.

There are further embodiments provided as follows.

### Embodiment 1

A user interface, which is implemented on a computer-readable medium and executable on a computer, for rendering a user being capable of independently establishing an application program for a mobile computing device having a capability controlling an input and output interface for a mobile computing device, wherein the input and output interface adopts a wireless communication protocol for bi-directionally communicating with an external device. The user interface comprises an input and output interface management module configured to render the user to define contents for the wireless communication protocol.

### Embodiment 2

In the user interface according to above-mentioned embodiment, the input and output interface management module is configured to render the user to customize the contents for the wireless communication protocol through at least a click selection operation.

### Embodiment 3

In the user interface according to above-mentioned embodiment 2 or 3, the user interface further comprises a combination of data structure setup pages configured to render the user being capable of independently configuring a displaying content of the application program for a mobile computing device through a click selection operation; and a simulation page configured to correspondingly simulate the configured displaying contents achieved by the data structure setup page on the mobile computing device about a real displaying situation.

### Embodiment 4

In the user interface according to any of the above-mentioned embodiments 2-4, the combination of data structure setup pages comprises a series of multilayered data configuration pages, each of which pages vertically hyperlinks with one another and further comprises a hyper linker linking to another page, and the user links to one of an upper-layer data configuration page and a next-layer data configuration page through operating the hyper linker.

### Embodiment 5

An application program establishing method for a mobile computing device which renders a user to access an establishing platform having a user interface through a browser for establishing an application program for a mobile computing device, wherein the application program has capability controlling an input and output interface for a mobile computing device, and the input and output interface adopts a wireless communication protocol for bi-directionally communicating with an external device. The method comprises step of providing the user interface which comprises an input/output interface management module configured to render the user to define contents for the wireless communication protocol.

### Embodiment 6

In the application program according to above-mentioned embodiment, the input/output interface management module is configured to render the user to customize the contents for the wireless communication protocol through at least a click selection operation.

### Embodiment 7

An application program establishing system for a mobile computing device which renders a user to access an establishing platform having a user interface through a browser for establishing an application program for a mobile computing device, wherein the application program has capability controlling an input and output interface for a mobile computing device, and the input and output interface adopts a wireless communication protocol for bi-directionally communicating with an external device. The system comprises a cloud computing server with the establishing platform installed thereon; and a user end linking to the cloud computing server through an Internet where the user accesses the establishing platform through the browser, wherein the establishing platform further comprises an input/output interface management module configured to render the user to define contents for the wireless communication protocol.

### Embodiment 8

In the application program according to above-mentioned embodiment, the mobile computing device has one module selected from a geographic information system (GIS) module, a global positioning system (GPS) module and a location based service (LBS) module, and the application program for the mobile computing device is an application program which is based on one of a geographic information system (GIS), a global positioning system (GPS) and a location based service (LBS).

### Embodiment 9

In the application program according to above-mentioned embodiment 7 or 8, the establishing platform is a platform utilizing a cloud computing technology regarding a Platform as a Service (PaaS).

### Embodiment 10

In the application program according to any one of the above-mentioned embodiments 7-9, the mobile computing device is one selected from a smart phone, a tablet and a personal digital assistant.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. A user interface, which is implemented on a computer-readable medium and executable on a computer, for rendering a user being capable of independently establishing an application program for a mobile computing device having a capability controlling an input and output interface for a mobile computing device, wherein the input and output interface adopts a wireless communication protocol for bi-directionally communicating with an external device, comprising:
an input and output interface management module configured to render the user to define contents for the wireless communication protocol.

2. The user interface according to claim 1, wherein the input and output interface management module is configured to render the user to customize the contents for the wireless communication protocol through at least a click selection operation.

3. The user interface according to claim 1, further comprising:
a combination of data structure setup pages configured to render the user being capable of independently configuring a displaying content of the application program for a mobile computing device through a click selection operation; and
a simulation page configured to correspondingly simulate the configured displaying contents achieved by the data structure setup page on the mobile computing device about a real displaying situation.

4. The user interface according to claim 3, wherein the combination of data structure setup pages comprises a series of multilayered data configuration pages, each of which pages vertically hyperlinks with one another and further comprises a hyper linker linking to another page, and the user links to one of an upper-layer data configuration page and a next-layer data configuration page through operating the hyper linker.

5. An application program establishing method for a mobile computing device which renders a user to access an establishing platform having a user interface through a browser for establishing an application program for a mobile computing device, wherein the application program has capability controlling an input and output interface for a mobile computing device, and the input and output interface adopts a wireless communication protocol for bi-directionally communicating with an external device, comprising step of:
providing the user interface which comprises an input/output interface management module configured to render the user to define contents for the wireless communication protocol.

6. The user interface according to claim 5, wherein the input/output interface management module is configured to render the user to customize the contents for the wireless communication protocol through at least a click selection operation.

7. An application program establishing system for a mobile computing device which renders a user to access an establishing platform having a user interface through a browser for establishing an application program for a mobile computing device, wherein the application program has capability controlling an input and output interface for a mobile computing device, and the input and output interface adopts a wireless communication protocol for bi-directionally communicating with an external device, comprising:
a cloud computing server with the establishing platform installed thereon; and
a user end linking to the cloud computing server through an Internet where the user accesses the establishing platform through the browser,
wherein the establishing platform further comprises an input/output interface management module configured to render the user to define contents for the wireless communication protocol.

8. The system according to claim 7, wherein the mobile computing device has one module selected from a geographic information system (GIS) module, a global positioning system (GPS) module and a location based service (LBS) module, and the application program for the mobile computing device is an application program which is based on one of a geographic information system (GIS), a global positioning system (GPS) and a location based service (LBS).

9. The system according to claim 7, wherein the establishing platform is a platform utilizing a cloud computing technology regarding a Platform as a Service (PaaS).

10. The system according to claim 7, wherein the mobile computing device is one selected from a smart phone, a tablet and a personal digital assistant.
